(19) United States
(12) Patent Application Publication
(10) Pub. No.: US 2020/0380581 A1
(43) Pub. Date: Dec. 3, 2020

(54) MEDICAL INSTITUTION SELECTION SUPPORT APPARATUS

(71) Applicant: CANON MEDICAL SYSTEMS CORPORATION, Otawara-shi (JP)

(72) Inventors: Mariko SHIBATA, Nasushiobara (JP); Narumi Sasayama, Nasushiobara (JP); Keisuke Hashimoto, Nasushiobara (JP); Michitaka Sugawara, Utsunomiya (JP); Katsuhiko Fujimoto, Saitama (JP); Satoshi Ikeda, Edinburgh (GB); Shintaro Niwa, Nasushiobara (JP)

(73) Assignee: CANON MEDICAL SYSTEMS CORPORATION, Otawara-shi (JP)

(21) Appl. No.: 16/877,626

(22) Filed: May 19, 2020

(30) Foreign Application Priority Data
May 28, 2019 (JP) 2019-099523

(51) Int. Cl. G06Q 30/06

(52) U.S. Cl. CPC G06Q 30/0631

(57) ABSTRACT

A medical institution selection support apparatus according to an embodiment includes a processing circuitry. The processing circuitry receives a search request for a medical institution. The processing circuitry outputs a search result in accordance with an overall evaluation value based on an evaluation value in accordance with personal information of a user for an evaluation item for evaluating each of a plurality of the medical institutions and an importance degree of the evaluation item on which the personal information is reflected.

### CROSS-REFERENCE TO RELATED APPLICATIONS

This application is based upon and claims the benefit of priority from Japanese Patent Application No. 2019-099523, filed on May 28, 2019; the entire contents of which are incorporated herein by reference.

### FIELD

Embodiments described herein relate generally to a medical institution selection support apparatus.

### BACKGROUND

A system configured to recommend a product or service to a user has been conventionally known. Such a system recommends a product or service to the user based on a browsing history of web sites by the user and the like. However, the user may lose interest in a browsed product or the like. In such a case, the user may feel unpleasant about recommendation of a product or the like based on browsing in the past.

In a medical field, a known system recommends a medical institution in accordance with details of medical treatment and an area of hospitals. However, such a system does not recommend a medical institution based on an evaluation criterion by which a user selects a medical institution. In addition, when recommending a medical institution based on the history of browsing the web site of the medical institution, the medical institution recommendation system does not provide a result expected by the user in some cases due to the above-described reason.

### BRIEF DESCRIPTION OF THE DRAWINGS

FIG. 1 is a diagram illustrating an exemplary configuration of a medical institution recommendation system according to a first embodiment;

FIG. 2 is a block diagram illustrating an exemplary configuration of a medical institution evaluation system according to the first embodiment;

FIG. 3 is a block diagram illustrating an exemplary configuration of a personal AI system according to the first embodiment;

FIG. 4 is an explanatory diagram for description of adjustment of an importance degree of an evaluation item;

FIG. 5 is an explanatory diagram for description of a method of deriving a recommendation degree;

FIG. 6 is a sequence diagram illustrating the processing procedure of recommendation processing executed by the medical institution recommendation system according to the first embodiment;

FIG. 7 is a flowchart illustrating the processing procedure of visitability determination processing executed by the personal AI system according to the first embodiment;

FIG. 8 is a block diagram illustrating an exemplary configuration of a medical institution evaluation system according to a first modification of the first embodiment;

FIG. 9 is a block diagram illustrating an exemplary configuration of a medical institution evaluation system according to a second modification of the first embodiment;

FIG. 10 is a diagram illustrating an exemplary configuration of a medical institution recommendation system according to a second embodiment;

FIG. 11 is a block diagram illustrating an exemplary configuration of a personal AI system according to the second embodiment; and

FIG. 12 is a block diagram illustrating an exemplary configuration of a medical institution evaluation system according to the second embodiment.

### DETAILED DESCRIPTION

Embodiments of a medical institution selection support apparatus will be described below with reference to the accompanying drawings. The contents of an embodiment or modification may be applied to another embodiment or modification as well.

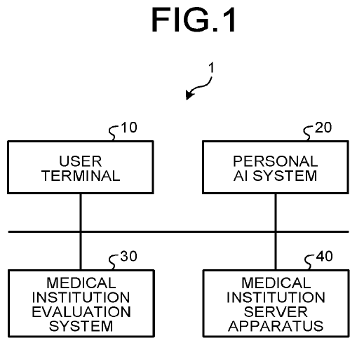

FIG. 1 is a diagram illustrating an exemplary configuration of a medical institution recommendation system 1 according to a first embodiment. The medical institution recommendation system 1 includes a user terminal 10, a personal artificial intelligence (AI) system 20, a medical institution evaluation system 30, and a medical institution server apparatus 40. The user terminal 10, personal AI system 20, the medical institution evaluation system 30, and the medical institution server apparatus 40 are connected with each other to perform communication therebetween through a network such as the Internet. In the medical institution recommendation system 1 illustrated in FIG. 1, the number of devices or systems of each kind is one, but a plurality of devices or systems of each kind may be provided.

The user terminal 10 is operated by a user. The user terminal 10 is achieved by, for example, a smartphone or a tablet terminal. The user terminal 10 receives, for example, an operation to search for a medical institution. The user terminal 10 outputs a result of the medical institution search, through a display or the like.

The personal AI system 20 is an exemplary medical institution selection support apparatus. The personal AI system 20 searches for a medical institution in accordance with personal information of the user. The personal AI system 20 is achieved by, for example, one or a plurality of server devices. In the following description of the first embodiment, it is assumed that a dental office is searched as a medical institution. However, the personal AI system 20 may search for another medical institution in place of a dental office. For example, a medical institution may be a health clinic, a hospital, a rehabilitation facility, or a nursing-care facility.

For example, when having received a search request for a medical institution from the user terminal 10, the personal AI system 20 requests the medical institution evaluation system 30 for evaluation of a medical institution based on the personal information of the user. In addition, the personal AI system 20 transmits, to the user terminal 10, a search result in accordance with an overall evaluation value based on an evaluation value in accordance with the personal information of the user for an evaluation item for evaluating each of a plurality of medical institutions and an importance degree of the evaluation item on which the personal information is reflected. Specifically, the personal AI system 20 transmits, as the search result, for example, information of a medical institution, which indicates a recommendation degree of the medical institution. An AI is a technology of performing various kinds of processing such as determination and estimation. The AI is generated by machine learning such as reinforcement learning, supervised learning, unsupervised learning, or deep learning. The AI may be generated by another method in place of these learning methods.

The medical institution evaluation system 30 is an exemplary external system. The medical institution evaluation system 30 associates a medical institution with an evaluation value of each evaluation item for the medical institution based on the personal information of the user. The medical institution evaluation system 30 is achieved by, for example, a server device. The first embodiment describes an example in which the medical institution evaluation system 30 is achieved by one server device, but the medical institution evaluation system 30 may be achieved by a plurality of server devices. Alternatively, the medical institution evaluation system 30 may be achieved by a plurality of server devices provided for each evaluation item of a medical institution.

The medical institution server apparatus 40 is a server device managed by a medical institution. The medical institution server apparatus 40 is achieved by, for example, a server device. The medical institution server apparatus 40 receives, for example, visit reservation of a medical institution.

In such a medical institution recommendation system 1, the user terminal 10 receives an operation to search for a medical institution such as a dental office. In the operation to search for a medical institution, the user terminal 10 may receive an operation to specify a search condition. For example, the user terminal 10 may receive, as the search condition, a visit purpose, a desired visit date and time, and the like. When having received the operation to search for a medical institution, the user terminal 10 requests the personal AI system 20 for search for a medical institution. Having received the search request, the personal AI system 20 transmits an evaluation request for evaluation of a medical institution to the medical institution evaluation system 30. The evaluation request includes the personal information of the user of the user terminal 10. The medical institution evaluation system 30 evaluates the medical institution for each evaluation item in accordance with the personal information of the user of the user terminal 10. Then, the medical institution evaluation system 30 transmits a result of the evaluation to the personal AI system 20.

The personal AI system 20 receives the evaluation result from the medical institution evaluation system 30. In addition, the personal AI system 20 determines the rank of the importance degree of each evaluation item based on the personal information of the user of the user terminal 10. The personal AI system 20 calculates an overall evaluation value by multiplying, by a weight determined for each rank of the importance degree, the evaluation value of the medical institution for each evaluation item, which is determined by the medical institution evaluation system 30. In addition, the personal AI system 20 sets the rank of the overall evaluation value of the medical institution as the recommendation degree of the medical institution. Then, the personal AI system 20 transmits information in which the recommendation degree of the medical institution is indicated to the user terminal 10 as medical institution recommendation information that is information of a medical institution recommended by the medical institution recommendation system 1.

The personal AI system 20 may query whether a medical institution can accept the user. In this case, the personal AI system 20 transmits information of a medical institution having responded that the user can accept to the user terminal 10 as the medical institution recommendation information that is information of a medical institution recommended by the medical institution recommendation system 1. In addition, when the user terminal 10 has received an operation to select a medical institution to be visited, the personal AI system 20 may register visit reservation to the medical institution server apparatus 40 of the selected medical institution.

The following describes the configuration of the medical institution evaluation system 30 according to the first embodiment.

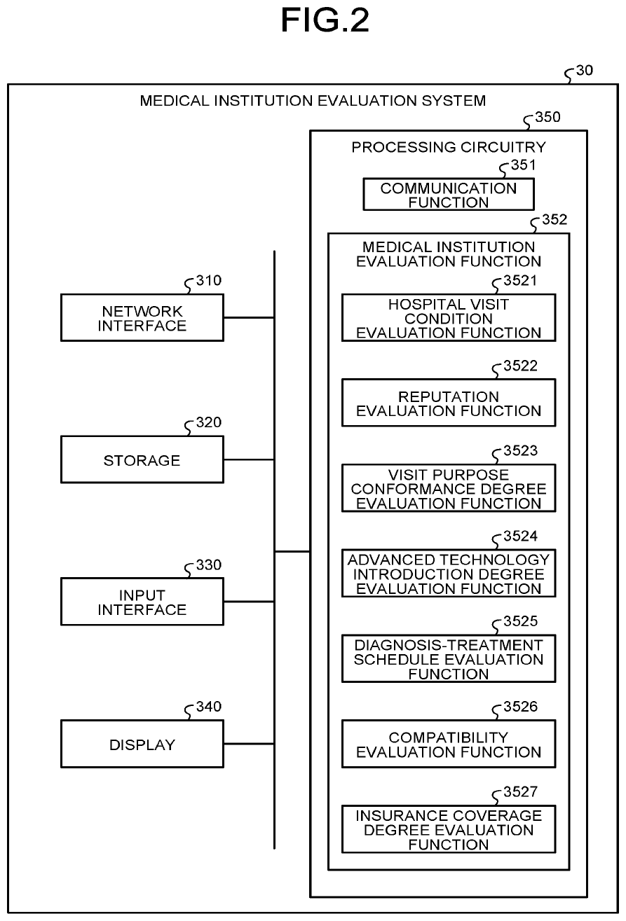

FIG. 2 is a block diagram illustrating an exemplary configuration of the medical institution evaluation system 30 according to the first embodiment. As illustrated in FIG. 2, the medical institution evaluation system 30 according to the first embodiment includes a network interface 310, a storage 320, an input interface 330, a display 340, and a processing circuitry 350.

The network interface 310 is connected with the processing circuitry 350 and controls transmission and communication of various kinds of data, which is performed among the user terminal 10, the personal AI system 20, and the medical institution server apparatus 40 through a network. More specifically, the network interface 310 receives various kinds of information from each system and outputs the received information to the processing circuitry 350. For example, the network interface 310 is achieved by a network card, a network adapter, a network interface controller (NIC), or the like.

The storage 320 is connected with the processing circuitry 350 and stores various kinds of data. For example, the storage 320 is achieved by a semiconductor memory element such as a random access memory (RAM) or a flash memory, a hard disk, an optical disk, or the like.

The input interface 330 converts, into an electric signal, an input operation received from an operator and outputs the electric signal to the processing circuitry 350. For example, the input interface 330 is achieved by an input device such as a truck ball, a switch button, a mouse, a keyboard, a touch pad through which an input operation is performed in accordance with touch on an operation surface, a touch screen as integration of a display screen and a touch pad, a non-contact input interface using an optical sensor, or a voice input interface. The input interface 330 may be a control circuit such as a connection interface configured to receive an electronic signal corresponding to an operation from an operation device provided separately from the medical institution evaluation system 30.

The display 340 displays various kinds of information and various kinds of images output from the processing circuitry 350. For example, the display 340 is achieved by a display device such as an organic electroluminescence (EL) monitor, a liquid crystal monitor, a cathode ray tube (CRT) monitor, or a touch panel. For example, the display 340 displays a graphical user interface (GUI) for receiving an instruction from the operator, image data for various kinds of display, and results of various kinds of processing performed by the processing circuitry 350.

The processing circuitry 350 controls each component included in the medical institution evaluation system 30. For example, the processing circuitry 350 is achieved by a processor. More specifically, the processing circuitry 350 according to the first embodiment has a communication function 351 and a medical institution evaluation function 352. The medical institution evaluation function 352 of the processing circuitry 350 has a hospital visit condition evaluation function 3521, a reputation evaluation function 3522, a visit purpose conformance degree evaluation function 3523, an advanced technology introduction degree evaluation function 3524, a diagnosis-treatment schedule evaluation function 3525, a compatibility evaluation function 3526, and an insurance coverage degree evaluation function 3527.

For example, processing functions executed by the communication function 351 and the medical institution evaluation function 352 as components of the processing circuitry 350 illustrated in FIG. 2 are each stored in the storage 320 in the form of computer-executable program. The processing circuitry 350 is a processor configured to achieve a function corresponding to each computer program by reading and executing the computer program from the storage 320. In other words, the processing circuitry 350 having read each computer program has the corresponding function illustrated in the processing circuitry 350 in FIG. 2.

All processing functions of the communication function 351 and the medical institution evaluation function 352 may be recorded in the storage 320 in the form of a single computer-executable program. For example, such a computer program is also referred to as a medical institution evaluation computer program. In this case, the processing circuitry 350 achieves the communication function 351 and the medical institution evaluation function 352 corresponding to the medical institution evaluation computer program by reading the medical institution evaluation computer program from the storage 320 and executing the read medical institution evaluation computer program.

The communication function 351 controls the network interface 310 to execute communication with devices and systems connected with the network. For example, the communication function 351 receives an evaluation request for evaluation of each evaluation item for a medical institution. The evaluation request includes the personal information of the user of the user terminal 10 having requested a search. When the evaluation of each evaluation item for a medical institution is executed, the communication function 351 transmits an evaluation result in which the evaluation value of each evaluation item is indicated.

The medical institution evaluation function 352 evaluates a medical institution for each evaluation item based on the personal information of the user. The personal information may be personal input information or personal characteristic information. The personal input information is information input by the user as an individual. The personal characteristic information is information on personal characteristics of the user. More specifically, the personal characteristic information is information based on a result of sensing by a sensor configured to sense the user as an individual. For example, the personal characteristic information is information based on a result of sensing by a sensor having a letter recognition function, a voice recognition function, a position recognition function, or the like. Specifically, the medical institution evaluation function 352 evaluates a medical institution based on the personal information that is information input by the user as an individual. Alternatively, the medical institution evaluation function 352 evaluates a medical institution based on the personal information that is information based on a result of sensing by a sensor configured to sense the user as an individual. The medical institution evaluation function 352 has various kinds of functions to evaluate a medical institution for each evaluation item. More specifically, the medical institution evaluation function 352 has the hospital visit condition evaluation function 3521, the reputation evaluation function 3522, the visit purpose conformance degree evaluation function 3523, the advanced technology introduction degree evaluation function 3524, the diagnosis-treatment schedule evaluation function 3525, the compatibility evaluation function 3526, and the insurance coverage degree evaluation function 3527. The medical institution evaluation function 352 causes the communication function 351 to transmit the evaluation values of the evaluation items, which are results of evaluation by these functions, as evaluation results of respective evaluation items. The functions included in the medical institution evaluation function 352 illustrated in FIG. 2 are functions for evaluating a dental office, for example.

The hospital visit condition evaluation function 3521 evaluates a medical institution based on the easiness of visit to the medical institution by the user. More specifically, the hospital visit condition evaluation function 3521 evaluates a medical institution based on the personal information of the user received from the personal AI system 20. In other words, the hospital visit condition evaluation function 3521 sets a high evaluation value when it is easy for the user to visit a medical institution as an evaluation target.

For example, the hospital visit condition evaluation function 3521 acquires, as the personal information of the user, the position information of a home, an office, and the like of the user and information indicating transportation regularly used by the user. The position information is information such as an address, a land-line phone number, latitude, and longitude. The hospital visit condition evaluation function 3521 disposes the position information of the home, the office, and the like of the user and the position information of a medical institution on map information. Then, the hospital visit condition evaluation function 3521 sets a high evaluation value when the medical institution is close to the home, the office, or the like of the user or when the medical institution can be visited through the transportation regularly used by the user. When there is a place visited by the user on a daily basis in addition to the home and the office of the user, the hospital visit condition evaluation function 3521 may evaluate the easiness of visit from the place to the medical institution.

The reputation evaluation function 3522 evaluates a medical institution based on reputation by people having used the medical institution. More specifically, when there is a web site publishing a score given to the medical institution by patients and the like, the reputation evaluation function 3522 evaluates the medical institution based on the score. The reputation evaluation function 3522 may add the contents of inputting by the user when browsing the web site publishing the score to criteria for evaluation of the medical institution.

For example, the personal input information records an operation of inputting a negative content to the medical institution, reputation of which is browsed on a web site. Specifically, inputting of the personal input information of a negative content for the medical institution being browsed is recorded, for example, when the user has talked negative words to oneself while browsing reputation on the web site, has written negative text at a posting site or the like on the web site, or has given facial expression indicating a negative feeling. The reputation evaluation function 3522 sets, irrespective of the score, a low evaluation value to the medical institution for which a negative content is input. Accordingly, the medical institution for which the user has had a negative feeling is unlikely to be recommended.

The visit purpose conformance degree evaluation function 3523 evaluates a medical institution based on whether diagnosis and treatment are performed in accordance with a visit purpose of the user. For example, the user searching for a dental office has various kinds of visit purposes such as tooth decay treatment, orthodontic treatment, teeth brushing guidance, and medical treatment of for example, oral mucous membrane suspected of malignancy. The visit purpose conformance degree evaluation function 3523 searches for the field of expertise of a diagnosis and treatment department, a specialized outpatient department, or the like corresponding to a specified visit purpose. Then, the visit purpose conformance degree evaluation function 3523 evaluates the medical institution in accordance with the existence of the field of expertise and the like. In addition to the existence of the field of expertise, the visit purpose conformance degree evaluation function 3523 may evaluate the medical institution in accordance with whether diagnosis and treatment close to the specified visit purpose are given.

The advanced technology introduction degree evaluation function 3524 evaluates a medical institution based on the degree of advanced technology introduction at the medical institution. More specifically, the advanced technology introduction degree evaluation function 3524 evaluates the medical institution based on the degree of introduction of advanced medical treatment method, manipulation, and device. For example, the advanced technology introduction degree evaluation function 3524 evaluates the degree of advanced technology introduction by comparing information provided by the medical institution with, for example, guidelines and medical instrument information from a pharmaceuticals and medical devices agency (PMDA) and the like. In addition to the information provided by the medical institution, the advanced technology introduction degree evaluation function 3524 may evaluate the degree of advanced technology introduction based on information of instrument models and pictures, medical treatment methods, and the like registered to a web site showcasing the medical institution.

The diagnosis-treatment schedule evaluation function 3525 evaluates the medical institution based on the degree of match between visit date and time desired by the user and visit date and time at which the medical institution can accept the user. More specifically, the diagnosis-treatment schedule evaluation function 3525 compares desired date and time specified by the user with visit date and time at which each medical institution can accept the user and evaluates the medical institution based on the degree of match between both dates and times. The diagnosis-treatment schedule evaluation function 3525 may compare a schedule table of the user, which is registered in advance, a time at which the user can easily go out, and visit date and time at which each medical institution can accept the user.

The compatibility evaluation function 3526 evaluates a medical institution based on compatibility between the user and a medical professional working at the medical institution. More specifically, the compatibility evaluation function 3526 compares the personal characteristic information of the user and the personal characteristic information of each medical professional working at the medical institution and evaluates the medical institution based on the compatibility. For example, the compatibility evaluation function 3526 estimates the personal characteristic information of the user and the medical professional based on daily words, voice, facial expression, and sentences and used words in a diary or the like. Then, the compatibility evaluation function 3526 estimates the compatibility between both members based on the estimated personal characteristic information, thereby evaluating the medical institution. In addition to words, voice, facial expression, and sentences and used words in a diary or the like, the compatibility evaluation function 3526 may estimate the personal characteristic information based on a psychological test, a self-report, or the like.

The insurance coverage degree evaluation function 3527 evaluates a medical institution based on the ratio of self-paid treatment in medical payment to the medical institution. The self-paid treatment is treatment to which insurance is not applied. Insurance treatment is treatment to which insurance is applied. For example, the insurance coverage degree evaluation function 3527 sets an evaluation value in accordance with the ratio of the insurance treatment and the self-paid treatment. Alternatively, the insurance coverage degree evaluation function 3527 may set the evaluation value of the medical institution in accordance with the economic situation of the user, which is estimated from income information indicating income of the user, savings information indicating savings of the user, and the like, or is input by the user. For example, when the economic situation of the user is good, the insurance coverage degree evaluation function 3527 sets a higher evaluation value as the ratio of the self-paid treatment increases. When the economic situation of the user is poor, the insurance coverage degree evaluation function 3527 sets a higher evaluation value as the ratio of the insurance treatment increases.

The following describes the configuration of the personal AI system 20 according to the first embodiment.

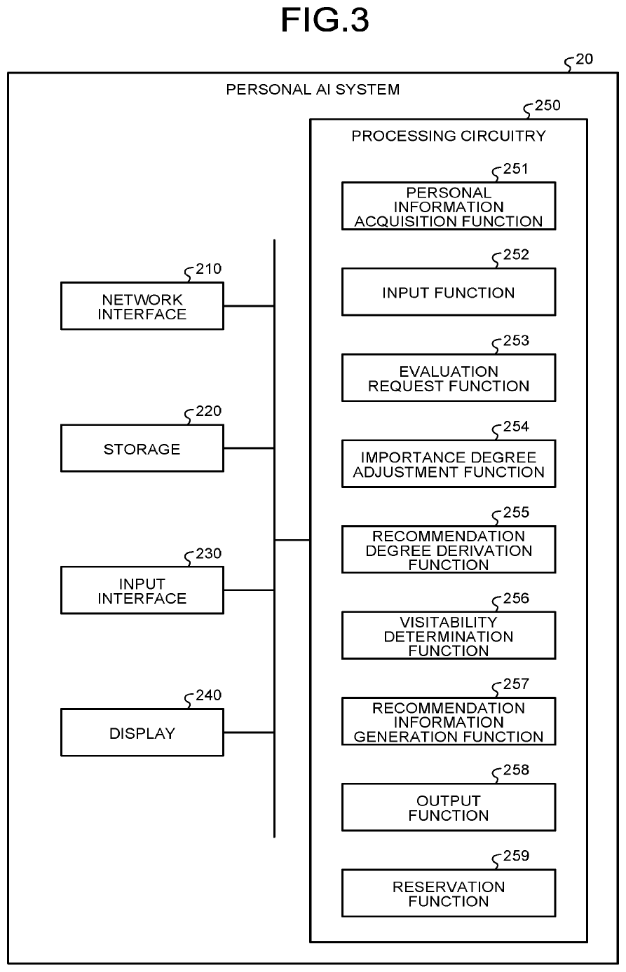

FIG. 3 is a block diagram illustrating an exemplary configuration of the personal AI system 20 according to the first embodiment. As illustrated in FIG. 3, the personal AI system 20 according to the first embodiment includes a network interface 210, a storage 220, an input interface 230, a display 240, and a processing circuitry 250.

The network interface 210 is connected with the processing circuitry 250 and controls transmission and communication of various kinds of data, which is performed among the user terminal 10, the medical institution evaluation system 30, and the medical institution server apparatus 40 through the network. More specifically, the network interface 210 receives various kinds of information from each system and outputs the received information to the processing circuitry 250. For example, the network interface 210 is achieved by a network card, a network adapter, a NIC, or the like.

The storage 220 is connected with the processing circuitry 250 and stores various kinds of data. For example, the storage 220 is achieved by a semiconductor memory element such as a RAM or a flash memory, a hard disk, an optical disk, or the like.

The input interface 230 converts, into an electric signal, an input operation received from the operator and outputs the electric signal to the processing circuitry 250. For example, the input interface 230 is achieved by an input device such as a truck ball, a switch button, a mouse, a keyboard, a touch pad through which an input operation is performed in accordance with touch on an operation surface, a touch screen as an integrated of a display screen and a touch pad, a non-contact input interface using an optical sensor, or a voice input interface. The input interface 230 may be a control circuit such as a connection interface configured to receive an electronic signal corresponding to an operation from an operation device provided separately from the personal AI system 20.

The display 240 displays various kinds of information and various kinds of images output from the processing circuitry 250. For example, the display 240 is achieved by a display device such as an organic EL monitor, a liquid crystal monitor, a CRT monitor, or a touch panel. For example, the display 240 displays a GUI for receiving an instruction from the operator, image data for various kinds of display, and results of various kinds of processing performed by the processing circuitry 250.

The processing circuitry 250 controls each component included in the personal AI system 20. For example, the processing circuitry 250 is achieved by a processor. More specifically, the processing circuitry 250 according to the first embodiment has a personal information acquisition function 251, an input function 252, an evaluation request function 253, an importance degree adjustment function 254, a recommendation degree derivation function 255, a visitability determination function 256, a recommendation information generation function 257, an output function 258, and a reservation function 259.

For example, processing functions executed by the personal information acquisition function 251, the input function 252, the evaluation request function 253, the importance degree adjustment function 254, the recommendation degree derivation function 255, the visitability determination function 256, the recommendation information generation function 257, the output function 258, and the reservation function 259 as components of the processing circuitry 250 illustrated in FIG. 3 are each stored in the storage 220 in the form of computer-executable program. The processing circuitry 250 is a processor configured to achieve a function corresponding to each computer program by reading and executing the computer program from the storage 220. In other words, the processing circuitry 250 having read each computer program has the corresponding function illustrated in the processing circuitry 250 in FIG. 3.

All processing functions of the personal information acquisition function 251, the input function 252, the evaluation request function 253, the importance degree adjustment function 254, the recommendation degree derivation function 255, the visitability determination function 256, the recommendation information generation function 257, the output function 258, and the reservation function 259 may be recorded in the storage 220 in the form of a single computer-executable program. For example, such a computer program is also referred to as a medical institution recommendation program. In this case, the processing circuitry 250 achieves the personal information acquisition function 251, the input function 252, the evaluation request function 253, the importance degree adjustment function 254, the recommendation degree derivation function 255, the visitability determination function 256, the recommendation information generation function 257, the output function 258, and the reservation function 259 corresponding to the medical institution recommendation program by reading the medical institution recommendation program from the storage 220 and executing the read medical institution recommendation program.

The personal information acquisition function 251 acquires the personal information of the user. Specifically, the personal information acquisition function 251 acquires the personal input information that is information input by the user as an individual and the personal characteristic information based on a result of sensing by a sensor configured to sense the user as an individual. More specifically, the personal information acquisition function 251 acquires the personal input information such as full name, age, sex, address, workplace address, income, deposit balance, allergy, and disease history of the user. In addition, the personal information acquisition function 251 acquires an activity history indicating activity of the user and an activity pattern as the personal characteristic information. For example, the personal information acquisition function 251 acquires a diary written by the user, words spoken by the user, facial expression of the user, the activity time of the user, the activity range of the user, products bought by the user, and shops or the like frequently used by the user. In addition, the personal information acquisition function 251 acquires, as the personal input information, conditions on medical institutions when the user has requested the medical institution recommendation system 1 to provide information of a recommended medical institution. In other words, the personal information acquisition function 251 acquires, as the personal input information, what kind of medical institution the user asks information for.

The input function 252 is an exemplary input unit. The input function 252 receives a search request for a medical institution. More specifically, when the user terminal 10 has received an operation requesting search for a medical institution, the input function 252 receives the search request from the user terminal 10.

The evaluation request function 253 transmits an evaluation request for the evaluation value of each evaluation item for evaluating a medical institution to the medical institution evaluation system 30. In addition, the evaluation request function 253 receives, from the medical institution evaluation system 30, an evaluation result in which the evaluation value of each evaluation item is indicated. The timing of transmitting the evaluation request may be optionally changed. For example, the evaluation request function 253 may transmit the evaluation request when the input function 252 has received the search request from the user terminal 10 or may transmit the evaluation request before receiving the search request by periodically transmitting the evaluation request.

The importance degree adjustment function 254 is an exemplary adjustment unit. The importance degree adjustment function 254 adjusts the importance degree of an evaluation item based on the personal information of the user. Specifically, the importance degree adjustment function 254 reflects the personal information of the user onto the importance degree of an evaluation item for a medical institution. The following describes a cause for adjustment of the importance degree for each evaluation item for a medical institution by the importance degree adjustment function 254. However, the following description is merely exemplary, and the importance degree adjustment function 254 may adjust the importance degree by another cause. A cause for adjustment of the importance degree of each evaluation item may be optionally settable.

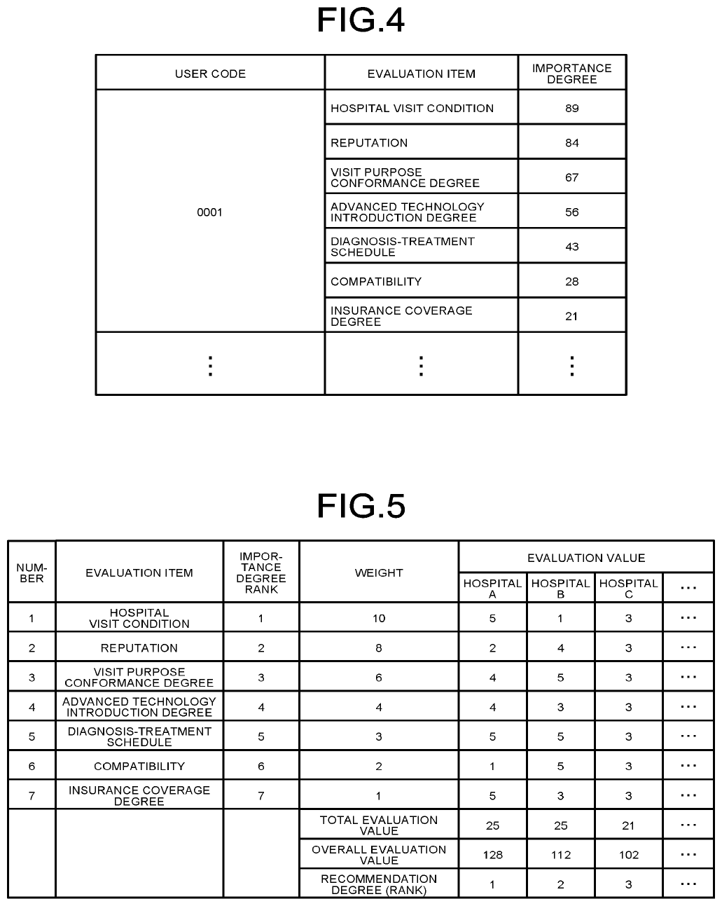

FIG. 4 is an explanatory diagram for description of adjustment of the importance degree of each evaluation item. The importance degree adjustment function 254 determines the importance degree of each evaluation item for each user code with which the user is identifiable. FIG. 4 lists, as exemplary evaluation items for a dental office, a hospital visit condition, reputation, a visit purpose conformance degree, an advanced technology introduction degree, a diagnosis-treatment schedule, compatibility, and an insurance coverage degree. However, the evaluation items are optional. In FIG. 4, a higher numerical value indicates a higher importance degree. However, a lower numerical value may indicate a higher importance degree.

The importance degree adjustment function 254 determines the importance degree of the hospital visit condition among the evaluation items based on, for example, the personal characteristic information of the user. For example, when the activity range of the user is determined based on a position information record and such a personal characteristic is determined that the user is unlikely to visit various places, it is thought that the easiness of visit to a medical institution is important for the user. Thus, the importance degree adjustment function 254 increases the importance degree of the hospital visit condition when the user has a shopping or a service in a predetermined range from the home or the office. The importance degree adjustment function 254 decreases the importance degree of the hospital visit condition when it is determined that the user often has shopping and services out of the predetermined range of the home or the office.

The importance degree adjustment function 254 determines the importance degree of the reputation among the evaluation items based on the personal characteristic information of the user. For example, when the user frequently browses web sites on which evaluation of products, services, and the like is indicated, it is thought that the reputation of a medical institution is important for the user. Thus, the importance degree adjustment function 254 increase the importance degree of the reputation each time the user browses web sites on which evaluation is indicated. The importance degree adjustment function 254 decreases the importance degree of the reputation when the user has not browsed web sites on which evaluation is indicated for a predetermined duration.

The importance degree adjustment function 254 determines the importance degree of the visit purpose conformance degree among the evaluation items based on the personal input information of the user. For example, when the user terminal 10 receives an operation to search for a medical institution and a visit purpose is clearly specified, it is thought that the visit purpose conformance degree is important for the user. Specifically, when the user terminal 10 receives presentation of a medical institution and a treatment department such as “esthetic dentist” is specifically indicated, the importance degree of the visit purpose conformance degree is set to be high. When the user terminal 10 receives an operation to search for a medical institution and a symptom such as “toothache” is indicated, the importance degree of the visit purpose conformance degree is set to be low.

The importance degree adjustment function 254 determines the importance degree of the advanced technology introduction degree among the evaluation items based on the personal characteristic information of the user. For example, when the user browses web sites showcasing latest medical treatment methods and medical treatment instruments, it is thought that the advanced technology introduction degree of a medical institution is important for the user. Thus, the importance degree adjustment function 254 increases the importance degree of the advanced technology introduction degree each time the user browses web sites showcasing latest medical treatment methods and the like. The importance degree adjustment function 254 decreases the importance degree of the advanced technology introduction degree when the user has not browsed web sites showcasing latest medical treatment methods and the like for a predetermined duration.

The importance degree adjustment function 254 determines the importance degree of the diagnosis-treatment schedule among the evaluation items based on the personal input information of the user. For example, when the user terminal 10 receives an operation to search for a medical institution and treatment desired date and time are clearly specified, it is thought that the diagnosis-treatment schedule is important for the user. Specifically, when the user terminal 10 receives presentation of a medical institution and treatment desired date and time such as “15:00 on March 7” are specifically indicated, the importance degree adjustment function 254 sets the importance degree the diagnosis-treatment schedule to be high. When the user terminal 10 receives presentation of a medical institution and a duration such as “next week” is indicated, the importance degree adjustment function 254 sets the importance degree of the diagnosis-treatment schedule to be low.

The importance degree adjustment function 254 determines the importance degree of the compatibility among the evaluation items based on the personal characteristic information of the user. For example, the importance degree adjustment function 254 increases the importance degree of the compatibility when words related to the compatibility are included in a diary, mail, spoken words, and facial expression. The importance degree adjustment function 254 decreases the importance degree of the compatibility when words related to the compatibility have not spoken for a predetermined duration. The importance degree adjustment function 254 may adjust the importance degree of the compatibility in accordance with the visit purpose. For example, the importance degree adjustment function 254 increases the importance degree of the compatibility when the user is to visit a treatment department set in advance, such as a gynecological department, a pediatric department, or a psychiatric department.

The importance degree adjustment function 254 determines the importance degree of the insurance coverage degree among the evaluation items based on the personal characteristic information of the user. For example, the importance degree adjustment function 254 increases the importance degree of the insurance coverage degree when the user has bought a discounted product. In other words, the importance degree adjustment function 254 sets a medical institution performing insurance treatment to be more likely to be recommended. The importance degree adjustment function 254 decreases the importance degree of the insurance coverage degree when the amount of assets of the user is larger than a threshold. In other words, the importance degree adjustment function 254 sets a medical institution performing self-paid treatment to be more likely to be recommended.

As illustrated in FIG. 3, the recommendation degree derivation function 255 is an exemplary derivation unit. The recommendation degree derivation function 255 derives the recommendation degree of each of a plurality of medical institutions in accordance with the overall evaluation value of the medical institution. FIG. 5 is an explanatory diagram for description of a method of deriving the recommendation degree. When having acquired the evaluation value of each evaluation item for each medical institution from the medical institution evaluation system 30, the recommendation degree derivation function 255 calculates a total evaluation value by adding the evaluation value of each evaluation item.

An importance degree rank indicating the descending order of the importance degree of each evaluation item is weighted in accordance with the rank. The recommendation degree derivation function 255 derives the overall evaluation value by multiplying a weight set for each evaluation item and the evaluation value of the evaluation item. Then, the recommendation degree derivation function 255 sets the recommendation degree to be the descending order of the overall evaluation value, in other words, the rank of the overall evaluation value.

The visitability determination function 256 is an exemplary determination unit. The visitability determination function 256 determines whether a medical institution is visitable by the user. In addition, the visitability determination function 256 determines whether the medical institution is visitable by the user in a set time. Specifically, the visitability determination function 256 queries the medical institution server apparatus 40 for whether the medical institution is visitable by the user. In addition, the visitability determination function 256 queries the medical institution server apparatus 40 for whether the medical institution is emergently visitable by the user.

Emergently visit means visit in a set time from the current date and time. More specifically, the visitability determination function 256 queries, in the order of the recommendation degree, the medical institution server apparatus 40 of each medical institution for whether the medical institution is emergently visitable by the user. The visitability determination function 256 queries the medical institution server apparatus 40 of each medical institution until a recommendation degree threshold set in advance is reached.

The recommendation information generation function 257 generates the medical institution recommendation information in accordance with the overall evaluation value based on the evaluation value in accordance with the personal information of the user for an evaluation item for evaluating each of a plurality of medical institutions and the importance degree of the evaluation item on which the personal information is reflected. The medical institution recommendation information includes information of one or more medical institutions and the recommendation degree of each medical institution. The medical institution recommendation information may additionally include medical institution information indicating a medical institution determined to be emergently visitable by the visitability determination function 256.

The output function 258 is an exemplary output unit. The output function 258 outputs a search result in accordance with the overall evaluation value based on the evaluation value in accordance with the personal information of the user for an evaluation item for evaluating each of a plurality of medical institutions and the importance degree of the evaluation item on which the personal information is reflected. In other words, the output function 258 outputs a search result in accordance with the overall evaluation value based on the evaluation value and the importance degree of the evaluation item, the evaluation value being obtained through evaluation by the medical institution evaluation system 30 configured to evaluate a medical institution based on the personal information that is information input by the user as an individual. The output function 258 outputs a search result in accordance with the overall evaluation value based on the evaluation value and the importance degree of the evaluation item, the evaluation value being obtained through evaluation by the medical institution evaluation system 30 configured to evaluate a medical institution based on the personal information that is information based on a result of sensing by a sensor configured to sense the user as an individual. More specifically, the output function 258 outputs, as a search result, the medical institution recommendation information in which the degree of recommendation derived by the recommendation degree derivation function 255 is indicated. In other words, the output function 258 transmits the medical institution recommendation information generated by the recommendation information generation function 257 to the user terminal 10. In this case, the output function 258 outputs the medical institution recommendation information in which a medical institution determined to be visitable by the visitability determination function 256 is indicated. When whether the medical institution is emergently visitable is queried by the visitability determination function 256, the output function 258 outputs the medical institution recommendation information of a medical institution visitable in a set time. The information output as a search result by the output function 258 is not limited to the medical institution recommendation information. For example, the output function 258 may output, as a search result, information of a medical institution having the highest recommendation degree, information of a medical institution having a higher recommendation degree, or a list indicating the recommendation degree of each medical institution.

The reservation function 259 is an exemplary reservation unit. The reservation function 259 reserves a visit to a medical institution indicated by the medical institution recommendation information. More specifically, when the user terminal 10 has received an operation to reserve a visit of a medical institution selected from the medical institution recommendation information, the reservation function 259 transmits visit reservation for the user to the medical institution server apparatus 40 of the selected medical institution. In this manner, the reservation function 259 reserves a visit to the medical institution.

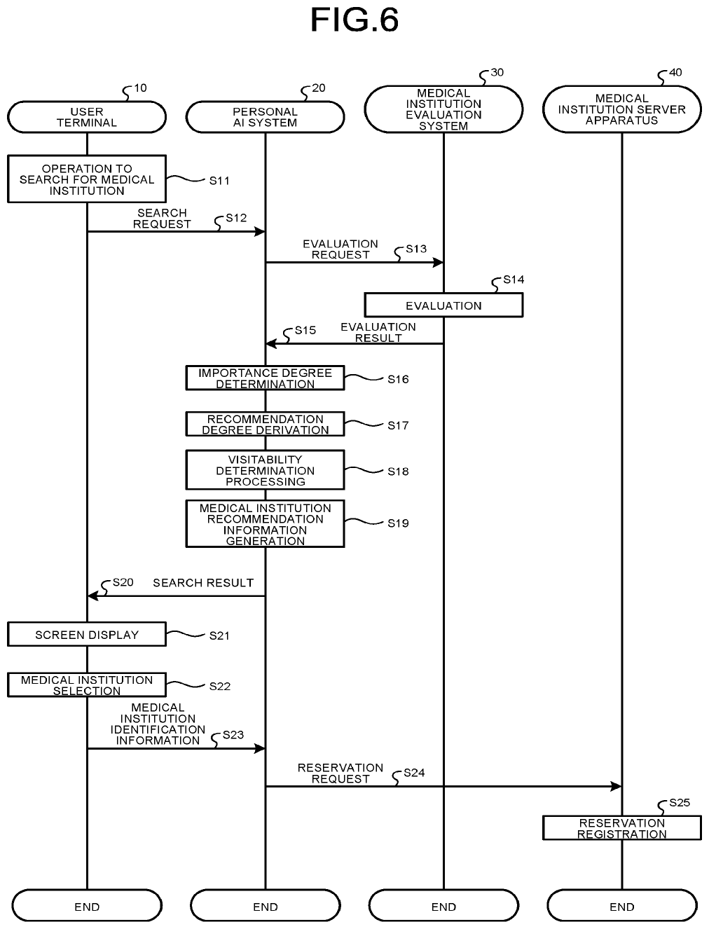

The following describes recommendation processing executed by the medical institution recommendation system 1 according to the first embodiment. FIG. 6 is a sequence diagram illustrating the processing procedure of the recommendation processing executed by the medical institution recommendation system 1 according to the first embodiment.

The user terminal 10 receives an operation to search for a medical institution (step S11).

The user terminal 10 transmits a search request for a medical institution to the personal AI system 20 (step S12).

The evaluation request function 253 of the personal AI system 20 transmits an evaluation request for the evaluation value of each evaluation item for evaluating a medical institution to the medical institution evaluation system 30 (step S13).

The medical institution evaluation function 352 of the medical institution evaluation system 30 evaluates each medical institution for each evaluation item based on the personal information of the user of the user terminal 10 having requested the search for a medical institution (step S14).

The evaluation request function 253 of the personal AI system 20 acquires a result of the evaluation of each medical institution (step S15).

The importance degree adjustment function 254 of the personal AI system 20 determines the importance degree of each evaluation item based on the personal information of the user (step S16). The importance degree adjustment function 254 may determine the importance degree of each evaluation item before recommendation of a medical institution is requested.

The recommendation degree derivation function 255 of the personal AI system 20 derives the recommendation degree in accordance with the overall evaluation value based on the evaluation value in accordance with the personal information of the user for an evaluation item for evaluating each of a plurality of medical institutions and the importance degree of the evaluation item on which the personal information is reflected (step S17).

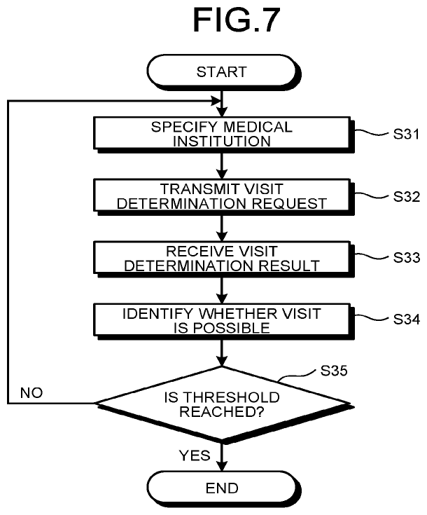

The visitability determination function 256 of the personal AI system 20 determines whether a medical institution, the rank of the recommendation degree of which is equal to or higher than a threshold is visitable by the user (step S18). This visitability determination processing of determining whether a medical institution is visitable by the user will be described with respect to FIG. 7 later.

The recommendation information generation function 257 of the personal AI system 20 generates the medical institution recommendation information in which the recommendation degree of each of one or more medical institutions is indicated (step S19).

The output function 258 of the personal AI system 20 transmits, as a search result, for example, the medical institution recommendation information to the user terminal 10 (step S20).

The user terminal 10 displays the medical institution recommendation information as a search result on a display such as a display (step S21). The user terminal 10 displays, in an identifiable manner, a medical institution emergently visitable and a medical institution, a visit to which needs a normal wait time.

The user terminal 10 receives an operation to select a medical institution to be visited by the user from among the one or more medical institution included in the medical institution recommendation information (step S22). The user terminal 10 transmits medical institution identification information in which the selected medical institution is indicated (step S23).

The reservation function 259 transmits a reservation request for reservation of a visit by the user to the medical institution server apparatus 40 of the medical institution indicated by the received medical institution identification information (step S24).

Having received the reservation request, the medical institution server apparatus 40 registers reservation for a visit by the user to reservation book information in which visit reservation is registered (step S25).

Accordingly, the medical institution recommendation system 1 ends the recommendation processing.

The following describes the visitability determination processing executed by the personal AI system 20 according to the first embodiment. FIG. 7 is a flowchart illustrating the processing procedure of the visitability determination processing executed by the personal AI system 20 according to the first embodiment.

The visitability determination function 256 specifies a medical institution at the highest rank of the recommendation degree among medical institutions (step S31).

The visitability determination function 256 transmits, to the medical institution server apparatus 40, a visit determination request querying whether it is possible to reserve a visit to the specified medical institution by the user (step S32). The visitability determination function 256 receives, from the medical institution server apparatus 40, a visit determination result indicating a result of the determination of whether it is possible to reserve a visit by the user (step S33).

The visitability determination function 256 identifies whether it is possible to reserve a visit to the medical institution based on the visit determination result (step S34).

The visitability determination function 256 determines whether the visitability is queried until the rank of the recommendation degree reaches a threshold (step S35). When the visitability is yet to be queried until the rank of the recommendation degree reaches the threshold (No at step S35), the visitability determination function 256 returns to step S31 and executes processing for the medical institution server apparatus 40 of a medical institution, the visitability of which is yet to be queried.

When the visitability is queried until the rank of the recommendation degree reaches the threshold (Yes at step S35), the visitability determination function 256 ends the visit determination processing.

As described above, the personal AI system 20 according to the first embodiment receives a search request for a medical institution from the user terminal 10. Then, the personal AI system 20 outputs a search result in accordance with the overall evaluation value based on the evaluation value in accordance with the personal information of the user for an evaluation item for evaluating each of a plurality of medical institutions and the importance degree of the evaluation item on which the personal information is reflected. Accordingly, the personal AI system 20 can support selection of a medical institution based on evaluation criteria of the user.

### First Modification of First Embodiment

The following describes a first modification of the first embodiment. In the first embodiment, it is assumed that a medical institution is a dental office. However, the medical institution is not limited to a dental office but may be a medical institution of another kind. A medical institution evaluation system 30a according to the first modification evaluates a rehabilitation facility as the medical institution.

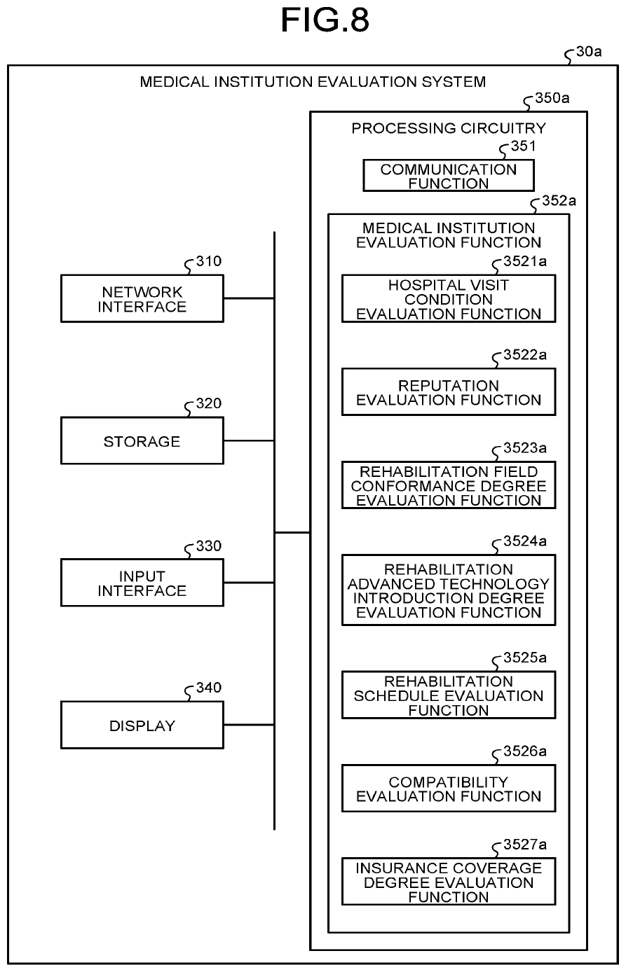

FIG. 8 is a block diagram illustrating an exemplary configuration of the medical institution evaluation system 30a according to the first modification of the first embodiment. The medical institution evaluation system 30a according to the first modification has a configuration same as that of the medical institution evaluation system 30a according to the first embodiment. However, components of a medical institution evaluation function 352a according to the first modification are different from those of the medical institution evaluation function 352 according to the first embodiment.

More specifically, the medical institution evaluation function 352a according to the first modification has a hospital visit condition evaluation function 3521a, a reputation evaluation function 3522a, a rehabilitation field conformance degree evaluation function 3523a, a rehabilitation advanced technology introduction degree evaluation function 3524a, a rehabilitation schedule evaluation function 3525a, a compatibility evaluation function 3526a, and an insurance coverage degree evaluation function 3527a.

The hospital visit condition evaluation function 3521a is same as the hospital visit condition evaluation function 3521 according to the first embodiment.

The reputation evaluation function 3522a is same as the reputation evaluation function 3522 according to the first embodiment.

The rehabilitation field conformance degree evaluation function 3523a evaluates whether it is possible to perform rehabilitation in a field desired by the user. Specifically, the rehabilitation field conformance degree evaluation function 3523a evaluates the degree of conformance between the field of rehabilitation performed at a rehabilitation facility and the field of rehabilitation specified by the user.

The rehabilitation advanced technology introduction degree evaluation function 3524a evaluates the degree of advanced technology introduction in rehabilitation.

The rehabilitation schedule evaluation function 3525a evaluates a medical institution based on the degree of match between visit date and time desired by the user and visit date and time at which the medical institution can accept the user.

The compatibility evaluation function 3526a evaluates the compatibility with a physical therapist or the like who supports rehabilitation.

The insurance coverage degree evaluation function 3527a evaluates a medical institution based on the ratio of self-paid treatment in medical payment to the medical institution.

Similarly to a case of a dental office according to the first embodiment, the importance degree adjustment function 254 of the personal AI system 20 adjusts the importance degree of each evaluation item for a rehabilitation facility based on the personal information of the user. The recommendation degree derivation function 255 derives the recommendation degree in accordance with the overall evaluation value of the rehabilitation facility based on the evaluation value of each evaluation item for evaluating a rehabilitation facility and the importance degree of the evaluation item on which the personal information of the user is reflected. Accordingly, the personal AI system 20 can output the medical institution recommendation information as a result of search for a rehabilitation facility.

As described above, the medical institution evaluation system 30a according to the first modification reflects the personal information of the user and determines the importance degree of an evaluation item for evaluating a rehabilitation facility. Then, the personal AI system 20 derives the recommendation degree in accordance with the overall evaluation value based on the evaluation value in accordance with the personal information of the user for the evaluation item for the rehabilitation facility and the importance degree of the evaluation item for the rehabilitation facility on which the personal information of the user is reflected. Accordingly, the personal AI system 20 according to the first modification can support selection of a rehabilitation facility in addition to a dental office.

### Second Modification of First Embodiment

The following describes a second modification of the first embodiment. In a first embodiment, it is assumed that a medical institution is a dental office. However, the medical institution is not limited to a dental office but may be a medical institution of another kind. A medical institution evaluation system 30b according to the second modification evaluates a visiting nursing-care facility as the medical institution.

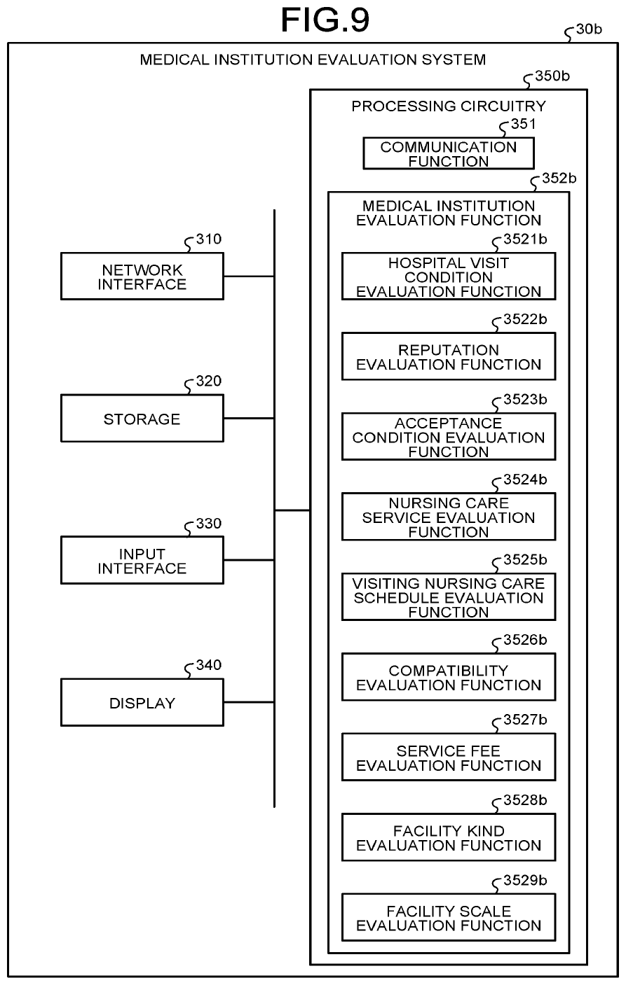

FIG. 9 is a block diagram illustrating an exemplary configuration of the medical institution evaluation system 30b according to the second modification of the first embodiment. The medical institution evaluation system 30b according to the second modification has a configuration same as that of the medical institution evaluation system 30 according to the first embodiment. However, components of a medical institution evaluation function 352b according to the second modification are different from those of the medical institution evaluation function 352 according to the first embodiment.

More specifically, the medical institution evaluation function 352b according to the second modification has a hospital visit condition evaluation function 3521b, a reputation evaluation function 3522b, an acceptance condition evaluation function 3523b, a nursing care service evaluation function 3524b, a visiting nursing care schedule evaluation function 3525b, a compatibility evaluation function 3526b, a service fee evaluation function 3527b, a facility kind evaluation function 3528b, and a facility scale evaluation function 3529b.

The hospital visit condition evaluation function 3521b is same as the hospital visit condition evaluation function 3521 according to the first embodiment.

The reputation evaluation function 3522b is same as the reputation evaluation function 3522 according to the first embodiment.

The acceptance condition evaluation function 3523b evaluates conditions on acceptance of the user at a visiting nursing-care facility. For example, the acceptance condition evaluation function 3523b evaluates how small the number of conditions on acceptance of the user is.

The nursing care service evaluation function 3524b evaluates contents of nursing care service at a visiting nursing-care facility.

The visiting nursing care schedule evaluation function 3525b evaluates a visiting nursing-care facility based on the degree of match between visit date and time desired by the user and visit date and time at which the medical institution can accept the user.

The compatibility evaluation function 3526b is same as the compatibility evaluation function 3526 according to the first embodiment.

The service fee evaluation function 3527b evaluates a charge for use at a visiting nursing-care facility.

The facility kind evaluation function 3528b evaluates the kind of service provided at a visiting nursing-care facility.

The facility scale evaluation function 3529b evaluates the scale of a visiting nursing-care facility.

Similarly to a case of a dental office according to the first embodiment, the importance degree adjustment function 254 of the personal AI system 20 adjusts the importance degree of each evaluation item for a visiting nursing-care facility based on the personal information of the user. The recommendation degree derivation function 255 derives the recommendation degree in accordance with the overall evaluation value of the visiting nursing-care facility based on the evaluation value of each evaluation item for evaluating the visiting nursing-care facility and the importance degree of the evaluation item on which the personal information of the user is reflected. Accordingly, the personal AI system 20 can output the medical institution recommendation information of the visiting nursing-care facility.

As described above, the medical institution evaluation system 30b according to the second modification reflects the personal information of the user and determines the importance degree of an evaluation item for evaluating a visiting nursing-care facility. Then, the personal AI system 20 derives the recommendation degree in accordance with the overall evaluation value based on the evaluation value in accordance with the personal information of the user for the evaluation item for the visiting nursing-care facility and the importance degree of each evaluation item for the visiting nursing-care facility on which the personal information of the user is reflected. Accordingly, the personal AI system 20 according to the second modification can support selection of a visiting nursing-care facility in addition to a dental office.

### Second Embodiment

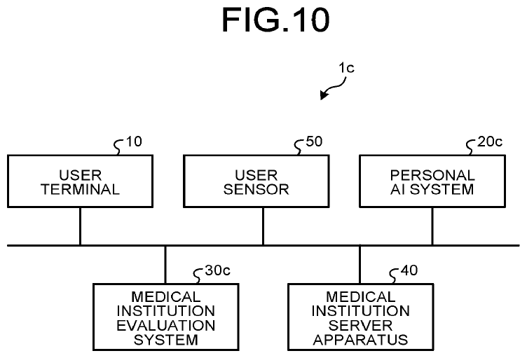

The following describes a second embodiment. FIG. 10 is a diagram illustrating an exemplary configuration of a medical institution recommendation system 1c according to the second embodiment. The medical institution recommendation system 1c according to the second embodiment includes the user terminal 10, a personal AI system 20c, a medical institution evaluation system 30c, and the medical institution server apparatus 40 as well as a user sensor 50.

The user sensor 50 detects the state of the user. For example, the user sensor 50 detects living body information such as body temperature, heart rate, blood pressure, or breathing of the user. Then, the user sensor 50 transmits the detected living body information to the personal AI system 20c.

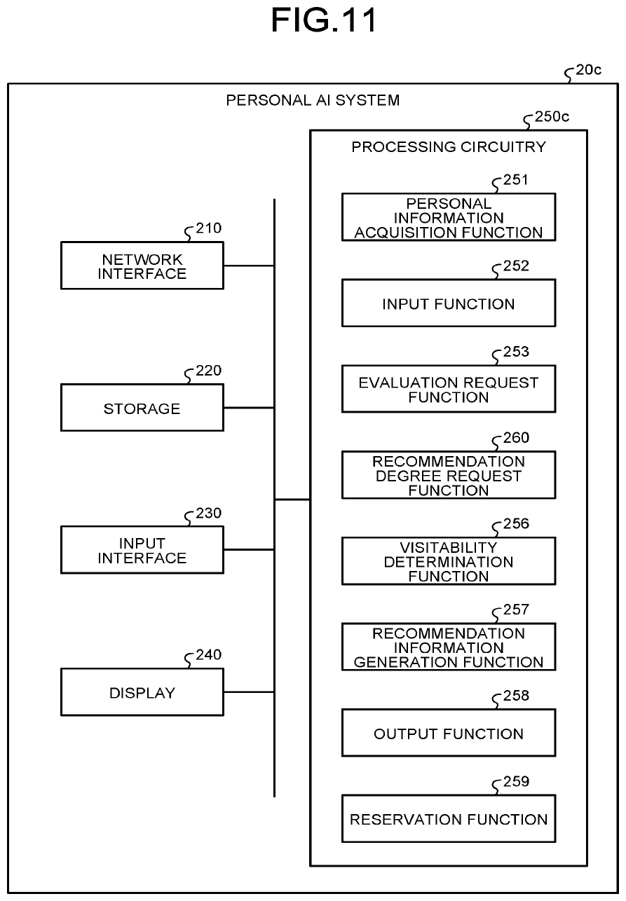

In the second embodiment, the personal AI system 20c requests the medical institution evaluation system 30c to determine the importance degree of an evaluation item for a medical institution and derive the recommendation degree of the medical institution. FIG. 11 is a block diagram illustrating an exemplary configuration of the personal AI system 20c according to the second embodiment. A processing circuitry 250c according to the second embodiment has a recommendation degree request function 260 in place of the importance degree adjustment function 254 and the recommendation degree derivation function 255.

The recommendation degree request function 260 is an exemplary request unit. The recommendation degree request function 260 requests the recommendation degree of each of a plurality of medical institutions in accordance with the overall evaluation value of the medical institution. Specifically, the recommendation degree request function 260 requests to determination of the importance degree of an evaluation item for the medical institution and derivation of the recommendation degree of the medical institution. The request for derivation of the recommendation degree includes the personal information of the user and the evaluation value of each evaluation item in accordance with the personal information of the user. The medical institution evaluation system 30c calculates the overall evaluation value based on the personal information of the user and the evaluation value of each evaluation item in accordance with the personal information of the user, which are included in the request for derivation of the recommendation degree. In addition, the medical institution evaluation system 30c derives the recommendation degree in accordance with the overall evaluation value. Then, the recommendation degree request function 260 acquires the recommendation degree as a reply to the request.

The visitability determination function 256 and the recommendation information generation function 257 execute processing same as that in the first embodiment. Then, the output function 258 outputs the medical institution recommendation information in which the recommendation degree acquired as a reply to the recommendation degree request function 260 is indicated.

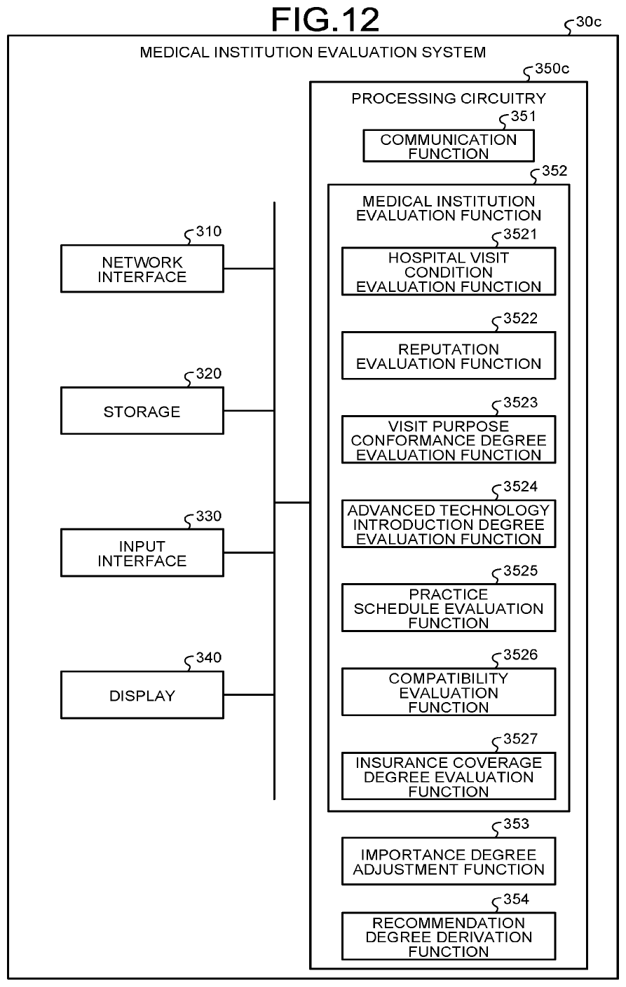

FIG. 12 is a block diagram illustrating an exemplary configuration of the medical institution evaluation system 30c according to the second embodiment. The medical institution evaluation system 30c determines the importance degree of a medical institution and derives the recommendation degree of the medical institution. A processing circuitry 350c according to the second embodiment has an importance degree adjustment function 353 and a recommendation degree derivation function 354 in addition to the communication function 351 and the medical institution evaluation function 352.

The importance degree adjustment function 353 determines the importance degree of the compatibility among the evaluation items based on the personal information of the user, which is included in the request for derivation of the recommendation degree. The recommendation degree derivation function 354 calculates the overall evaluation value by multiplying the evaluation value of each evaluation item for evaluating a medical institution, which is included in the request for derivation of the recommendation degree, by a weight in accordance with the importance degree of the evaluation item. In addition, the recommendation degree derivation function 354 derives the recommendation degree in accordance with the overall evaluation value.

In this manner, when having received the request for derivation of the recommendation degree, the medical institution evaluation system 30c determines the evaluation value of each evaluation item for a medical institution, adjusts the importance degree of each evaluation item, and derives the recommendation degree. Then, the medical institution evaluation system 30c transmits the recommendation degree of each medical institution to the personal AI system 20c.

The personal AI system 20c generates the medical institution recommendation information by using the recommendation degree of each medical institution, which is transmitted from the medical institution evaluation system 30c. The personal AI system 20c transmits the generated medical institution recommendation information to the user terminal 10. Accordingly, the user terminal 10 can display, on the display such as a display, the medical institution recommendation information in which the recommendation degree of each medical institution is indicated.

In addition, the personal AI system 20c can understand the state of the user by acquiring, from the user sensor 50, the living body information as the personal characteristic information indicating the state of the user. Thus, when the living body information indicates an abnormal value, the personal AI system 20c can transmit the request for derivation of the recommendation degree to the medical institution evaluation system 30c. Accordingly, the personal AI system 20c can transmit the request for derivation of the recommendation degree to the medical institution evaluation system 30c without an operation by the user.

The user terminal 10 can display the medical institution recommendation information in which the recommendation degree of each medical institution is indicated, on the display such as a display without receiving an operation. Then, when a medical institution is selected on the user terminal 10, the reservation function 259 of the personal AI system 20c can reserve a visit to the medical institution server apparatus 40 of the selected medical institution.

Since the personal AI system 20c acquires the living body information as the personal characteristic information, the personal AI system 20c can detect an emergency value indicating an emergency state such as unconsciousness of the user. Thus, when the living body information included in the personal characteristic information indicates emergency, the reservation function 259 of the personal AI system 20c can report to the medical institution server apparatus 40 of a medical institution even without reception of an operation from the user.

As described above, the medical institution recommendation system 1c according to the second embodiment includes the user sensor 50. The user sensor 50 detects the state of the user. In this manner, the personal AI system 20c can understand the state of the user through the user sensor 50, and thus, when information of a medical institution recommended by the medical institution recommendation system 1 is requested but specific conditions on the medical institution are not instructed, the personal AI system 20c can still recommend the medical institution. In addition, since the personal AI system 20c can recognize the state of the user through the user sensor 50, the personal AI system 20c can report, to a medical institution, anomaly having occurred to the user.

In the above-described embodiments, each processing function is achieved by the single processing circuitry 250, 350, 350a, 350b, or 350c, but the embodiments are not limited thereto. For example, the processing circuitries 250, 350, 350a, 350b, and 350c may be each configured as a combination of a plurality of independent processors, and each processor may achieve a processing function by executing the corresponding computer program. The processing functions of the processing circuitries 250, 350, 350a, 350b, and 350c may be each distributed or may be integrated to one or a plurality of the processing circuitries 250, 350, 350a, 350b, and 350c as appropriate.

The term “processor” used in the above description of the embodiments means, for example, a central processing unit (CPU), a graphics processing unit (GPU), or a circuit such as an application specific integrated circuit (ASIC) or a programmable logic device (for example, a simple programmable logic device (SPLD), a complex programmable logic device (CPLD), or a field programmable gate array (FPGA)). Instead of being stored in a memory, a computer program may be directly incorporated in a circuit of the processor. In this case, the processor achieves a function by reading and executing the computer program incorporated in the circuit. Each processor according to the present embodiment does not necessarily need to be configured by a single circuit, but may be configured by a plurality of independent circuits combined as one processor to achieve the function of the processor.

The computer program executed by the processor is incorporated in a read only memory (ROM), a storage unit, or the like in advance and provided. The computer program may be recorded and provided as a file of a format installable or executable on these devices in a computer-readable storage medium such as a compact disc (CD) ROM, a flexible disk (FD), a CD recordable (CD-R), or a digital versatile disc (DVD). The computer program may be stored on a computer connected with a network such as the Internet and may be provided or distributed by downloading through the network. For example, the computer program is constituted by modules including respective functional components. Each module is loaded and generated on a main storage device when the CPU as actual hardware reads the computer program from the storage medium such as a ROM and executes the computer program.

Each component of each device illustrated is functionally conceptual and does not necessarily need to be physically configured as illustrated in the drawings. In other words, the specific form of distribution and integration of the devices is not limited to those illustrated in the drawings, but the entire or part thereof may be functionally or physically distributed and integrated in arbitrary units in accordance with, for example, various loads and use statuses. Moreover, the entire or an optional part of each processing function performed at each device may be achieved by a CPU and a computer program analyzed and executed by the CPU or may be achieved as wired logic hardware.

The medical information collection method described in the above-described embodiments can be achieved by executing a computer program prepared in advance through a computer such as a personal computer or a workstation. The computer program may be distributed through a network such as the Internet. In addition, the computer program may be recorded in a computer-readable recording medium such as a hard disk, a flexible disk (FD), a CD-ROM, an MO, or a DVD, read from the recording medium by a computer, and executed.

According to at least one embodiment described above, it is possible to support selection of a medical institution based on evaluation criteria of a user.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A medical institution selection support apparatus comprising:
a processing circuitry configured to
receive a search request for a medical institution; and
output a search result in accordance with an overall evaluation value based on an evaluation value in accordance with personal information of a user for an evaluation item for evaluating each of a plurality of the medical institutions and an importance degree of the evaluation item on which the personal information is reflected.

2. The medical institution selection support apparatus according to claim 1, wherein the processing circuitry outputs a search result in accordance with the overall evaluation value based on the evaluation value and the importance degree of the evaluation item, the evaluation value being obtained through evaluation by an external system configured to evaluate a medical institution based on the personal information that is information input by the user as an individual.

3. The medical institution selection support apparatus according to claim 1, wherein the processing circuitry outputs a search result in accordance with the overall evaluation value based on the evaluation value and the importance degree of the evaluation item, the evaluation value being obtained through evaluation by an external system configured to evaluate a medical institution based on the personal information that is information based on a result of sensing by a sensor configured to sense the user as an individual.

4. The medical institution selection support apparatus according to claim 1, wherein the processing circuitry
derives a recommendation degree of each of a plurality of the medical institutions in accordance with the overall evaluation value of the medical institution, and
outputs, as the search result, information of the medical institution in which the derived degree of recommendation is indicated.

5. The medical institution selection support apparatus according to claim 1, wherein the processing circuitry
requests a recommendation degree of each of a plurality of the medical institutions in accordance with the overall evaluation value of the medical institution, and
outputs, as the search result, information of the medical institution in which the recommendation degree acquired as a reply to the request is indicated.

6. The medical institution selection support apparatus according to claim 4, wherein the processing circuitry
adjusts the importance degree of the evaluation item based on the personal information of the user, and
derives the recommendation degree in accordance with the overall evaluation value based on the adjusted importance degree and the evaluation value.

7. The medical institution selection support apparatus according to claim 1, wherein the processing circuitry
determines whether the medical institution is visitable by the user, and
outputs, as the search result, information of the medical institution determined to be visitable.

8. The medical institution selection support apparatus according to claim 7, wherein the processing circuitry
determines whether the medical institution is visitable by the user in a set time, and
outputs, as the search result, information of the medical institution that is visitable in the set time.

9. The medical institution selection support apparatus according to claim 1, wherein the processing circuitry reserves a visit to the medical institution included in information output as the search result.

10. The medical institution selection support apparatus according to claim 9, wherein the processing circuitry reports to the medical institution even without reception of an operation from the user when the personal information indicates emergency.
